(19) United States
(12) Patent Application Publication
(10) Pub. No.: US 2023/0403995 A1
(43) Pub. Date: Dec. 21, 2023

(54) ARRANGEMENT OF A CLOSED GREENHOUSE WITH OPTIMISED TEMPERATURE CONTROL AND ASSOCIATED MULTI-MODULE GREENHOUSE

(71) Applicant: Joël Despujols, Noumea (FR)

(72) Inventor: Joël Despujols, Noumea (FR)

(21) Appl. No.: 17/914,617

(22) PCT Filed: Mar. 26, 2021
(86) PCT No.: PCT/EP2021/057599

§ 371 Date: Sep. 26, 2022

(30) Foreign Application Priority Data
Mar. 26, 2020 (FR) FR20 02972

(51) Int. Cl. A01G 13/08; A01G 9/24; A01G 13/10

(52) U.S. Cl. CPC A01G 13/08; A01G 9/241; A01G 9/246; A01G 13/10

(57) ABSTRACT

Arrangement of a closed greenhouse (10) with optimised temperature control, including at least one module (10-1 to 10-n), comprising a framework and a peripheral film so as to constitute an enclosed space, comprising a front wall (16), a rear wall (18) and two side walls, left (20) and right (22) as well as a roof (24) with à ridge, as well as at least one access opening with an airlock, at least one evaporating panel (26) for water diffusion, a water supply circuit (32) and at least one interior air extractor (34), characterized in that said at least one interior air extractor (34) is disposed in the immediate vicinity of the ridge of the roof (24)

The invention relates to an arrangement of a closed greenhouse with optimised temperature control. The invention also includes an arrangement of a multi-module closed greenhouse.

In the context of global warming, crops, especially vegetable crops, are subject to attacks by pests, such as Macrolophus spp, Nezara bugs. There are nets for crop protection but their effectiveness is limited and they are complex to implement. And they are especially vulnerable to wind. In this context of virulent aggressors, the use of phytosanitary products is in strong decline and the goal is to sharply limit their use, not to mention the costs of these products themselves and of their use on the crops by personnel, even if the materials are sophisticated, in addition to their impact on health. One solution is to use greenhouses. Greenhouses have the advantage of allowing protection from climatic conditions, but it is necessary to be able to regulate the temperature, especially when it is too hot. For this purpose, it is possible to provide natural circulation with openings leading to natural convection. This way, the temperature is regulated but no protection is possible from parasites and pests.

The only solution to ensure the crop is protected at a regulated temperature is a so-called closed greenhouse. Greenhouses of this type are totally enclosed, with an airlock at the entrance and offer dynamic circulation using heaters equipped with filters. A tool to regulate the temperature and to lower the temperature consists of evaporating water from panels placed opposite the extraction points in order to create negative pressure in the greenhouse. These panels are traversed by the outside air and the humidity is captured by these panels and when the air passes through them, a change of state from liquid to vapor occurs. Some of the water is captured by gravity and collected for recycling. As soon as the air leaves the panel, in the outward/inward direction, the air entering the greenhouse is cooled adiabatically by evaporation from the surface of the panel. Thus, depending on the humidity level of the outside air, it is possible to lower the air temperature by evaporation of the water collected by the panels. For a temperature of 35° C. outside, for example, it is possible to lower the temperature to 21° C. for a relative humidity of the outside air of 15% and a lowering to 30° C. if the outside air has a relative humidity of 60%. It is also noted that the water evaporating and circulating in the greenhouse, ensures the hygrometric control of the air in the greenhouse. It is also understood that such a device is very dependent on the external conditions and remains complicated to implement when the external conditions are of the hot and humid type because the adiabatic output is even lower. Moreover, in conventional greenhouses, the panel surface is limited to the available wall surface on the opposite wall to the extraction and the ratio cannot be increased.

The purpose of this invention is to provide an architecture which aims to increase the panel area, its distribution and the extraction rate in order to significantly decrease the temperature. Thus, with the closed greenhouse architecture according to the present invention, the ratio of renewal rate to evaporating surfaces is increased. The primary purpose is to find additional evaporating surfaces and additional surfaces to receive additional air extractors, while maintaining the usable cultivation surface and the light penetration potential in the greenhouse. The purpose is also to operate using solar energy, since the more active the sun is, the higher the temperature to be regulated. If the sun heats up, the temperature of the greenhouse rises, so it is necessary to cool down the interior temperature, but as the sun radiates, photons are being generated in quantities, which allow the solar panels to generate electricity in quantities, thus creating a proportionality that is positively correlated. It is therefore possible to operate the closed greenhouse according to this invention by following the sun's lead, without the need to accumulate and store energy in a complex way. This arrangement according to this invention is perfectly in line with the “low tech” trend, a technology using little materials, energy and personnel and that requires little maintenance.

The closed greenhouse according to this invention is a total barrier to the penetration of insects while maintaining the maximum transmission of photosynthetic radiation for conservation of the organoleptic qualities of the cultivated species.

This invention is characterized by an arrangement of a closed greenhouse with optimised temperature control, including at least one module, comprising a framework and a peripheral film so as to constitute an enclosed space, comprising a front wall, a rear wall and two left and right side walls as well as a roof with a ridge, as well as at least one access opening with an airlock, at least one evaporating panel for water diffusion, a water supply circuit and at least one interior air extractor; this at least one interior air extractor is disposed in the immediate vicinity of the roof ridge so as to alleviate the aforementioned drawbacks.

This at least one interior air extractor is more particularly disposed vertically and in an even more particular way on vertical, recessed, roof slopes.

In addition, the diffusion panels are preferably disposed at ground level and on at least one side wall.

This invention is now described with the aid of examples that are solely illustrative and in no way limitative of the scope of the invention, and based on the attached drawings, in which the various figures represent:

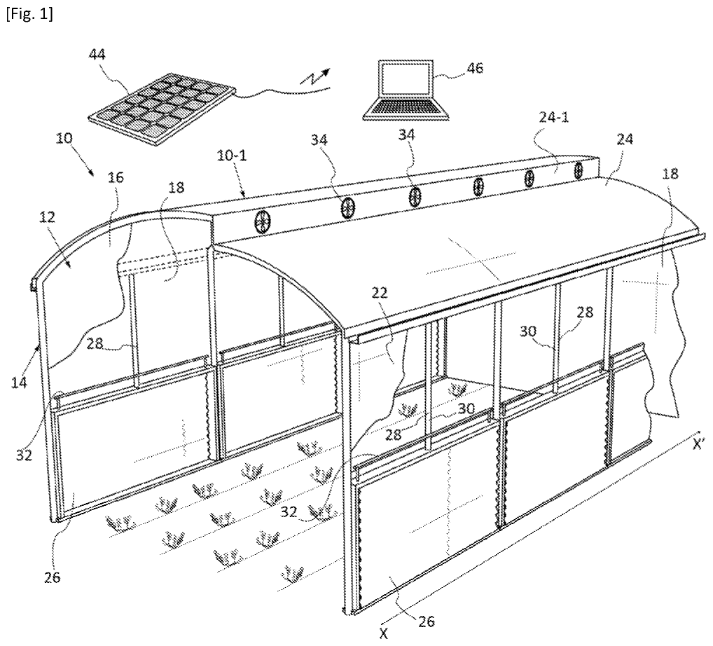

FIG. 1 represents a schematic perspective view of a module of a closed greenhouse arranged according to this invention,

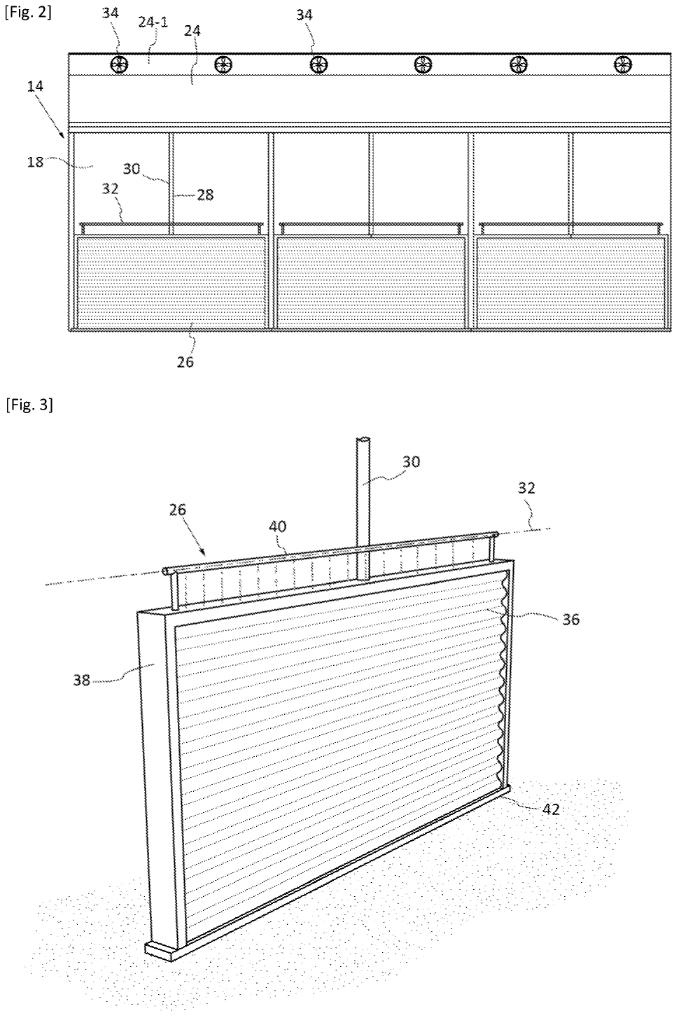

FIG. 2 represents a schematic side elevation view of the same module, from the inside of the side wall, showing the interior arrangement,

FIG. 3 represents a view of an evaporating panel for water diffusion,

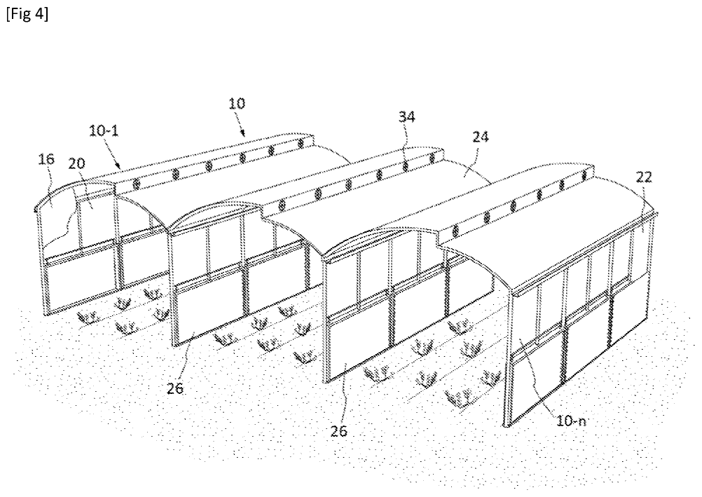

FIG. 4 represents a view of a closed greenhouse with several successive modules in the same space.

The arrangement of a closed greenhouse 10 according to this invention is illustrated in FIG. 1. This closed greenhouse 10 comprises a framework wrapped with a film 12 adapted to enclose the space defined by the framework 14, in a manner known per se. The fixing of the film on the framework, the architectural modalities of the framework, the braces and other mechanical elements are of no interest with respect to the invention, which can be applied to all types of closed greenhouses.

The closed greenhouse 10 is thus a fully enclosed space and for simplicity, only one module 10-1 is shown in this figure so as to allow for an easy and clear description. The closed greenhouse module 10-1 includes a front wall 16, a back wall 18, a left side wall 20 and a right side wall 22 and a roof 24.

The front wall 16 does not have any particularity except generally to provide an opening equipped with an airlock, not shown, in order to allow the entry and exit of the personnel, the machines and the plant materials. This front wall 16 is made of the same film as the other parts of the greenhouse. The back wall 18 is generally identical to the front wall 16 except for the entrance airlock which may or may not be present. The longitudinal dimension is seen along the axis XX′.

The right and left side walls are constituted of the film and do not present any constructive particularities. These right and left side walls may also have openings in place of or in addition to the openings in the front and rear walls. These right and left side walls ensure the continuity of the seal. At least one of the left and right side walls is equipped with evaporating diffusion panels 26. These evaporating diffusion panels 26 are positioned vertically close to the ground, i.e. at the level of the crop area. In the embodiment shown, the left 20 and right 22 walls are equipped with such diffusion evaporating panels 26. These diffusion evaporating panels 26 will be described in more detail later. These diffusion evaporating panels 26 constitute a continuous or discontinuous surface in close proximity to the relevant wall. These diffusion evaporating panels 26 are generally disposed within the film space so as to be fully integrated. Some diffusion evaporating panels 26 may also form a part of the enclosed enclosure in place of the film, the film being connected in a sealed manner to said panels.

The closed greenhouse 10 has external air intakes 28, which pass through the film in a sealed manner and open into the closed greenhouse enclosure. In this case, these external air intakes 28 are connected to the diffusion evaporating panels 26; via ducts 30 in the particular and non-limiting embodiment shown. In the case where the panels form a structural part of the wall, the supply of outside air is realized directly by suction through said panels. The external air intakes 28 are protected from any intrusion of pests and parasites by an anti-intrusion net with a suitable mesh size, for example from 250 μm to 730 μm.

The closed greenhouse 10 is also equipped with means for supplying water 32 to the evaporating diffusion panels 26. This water can always be renewed or partly recycled. In a known way, it is distributed in the upper part of each evaporating diffusion panel 26, so as to generate a gravitational surface flow over the whole surface of each evaporating diffusion panel 26.

The roof 24 is also made of the same film or of a film of a different nature according to the needs of mechanical resistance or specific needs for transmission of radiation if necessary, the tight connection being made with the other 4 side walls to constitute the closed enclosure. The roof shapes of closed greenhouses are generally vaulted or arched, symmetrical with respect to the side walls with a ridge. According to this invention the roof 24 includes at least one motorized indoor air extractor 34, in this case a line of motorized indoor air extractors 34. This at least one interior air extractor 34 is placed in immediate proximity to the ridge. Advantageously, the roof 24 of the closed greenhouse arranged according to this invention comprises at least one vertical, set-back roof section 24-1, which is discontinuous from the vaulted or arched shape of the roof, so as to position the extractors vertically. These interior air extractors 34 are tightly integrated into the film and carry, at least on one side, an anti-intrusion net of pests and parasites like the exterior air intakes 28. The interior air extractors 34, thus arranged, very strongly limit the impact on the ground as regards the shadow cast, especially if the general orientation of the greenhouse and the positioning of the roof setback are arranged in a way adapted to the path of the sun. Advantageously, for a homogeneity of the temperature in the closed greenhouse arranged according to this invention, a line of air extractors 34 oriented along the XX′ axis is provided. Advantageously, in order to favor a laminar rather than turbulent circulation, with a better temperature homogeneity in the closed greenhouse 10, the line of internal air extractors 34 is parallel to the line of diffusion evaporating panels 26.

The diffusion evaporating panels 26 are shown in FIG. 3 specifically and comprise cores 36 of porous material, such as cellulose fibers, the principal surface of which is oriented vertically, while in operation. These cores 36 are held in a frame 38, so as to constitute a monolithic element that is manipulatable and intended to be attached to a suitable support connected to the framework of the closed greenhouse. The cores 36 can have a surface shaped with corrugations in order to provide a surface with increased diffusion. Advantageously also, each outside air duct 30 of the outside air intakes 28, opens into the core 36 of a diffusion evaporating panel 26 so that air flows through said core 36. Each evaporating diffusion panel 26 comprises in its upper part a ramp 40 for the delivery of water from the water supply circuit in the form of nozzles for example, preferably oriented upwards to avoid clogging by any limescale that may be present. In the lower part of each evaporating diffusion panel 26, water recovery means 42 are provided in the form of a gutter, for example. These water recovery means are integrated into the water supply circuit 32 for possible recycling.

In order to be able to supply energy to the water supply circuit 32, which necessarily include pumps and other electric circulators, as well as to the air extractors 28, which also include electric motors, a connection to photovoltaic panels 44 is provided. The advantage is that the electrical power needs of the closed greenhouse arranged according to this invention and the production of electrical power by photovoltaic panels follow the same daily curve, which dispenses with important storage means, only a buffer storage is necessary as in any photovoltaic installation. A connection to the power supply network, when possible, is generally provided in case of failure or specific requirements.

Advantageously, the closed greenhouse according to this invention is equipped with a computerized programmable control means 46, in order to manage the various parameters of the different elements, such as the water supply, the flow rate of extracted air, according to the parameters of the outside air and the parameters sought in the greenhouse.

The operation of the closed greenhouse arranged according to this invention is now described. The ground area covered by the closed greenhouse according to this invention is completely available for cultivation, except for the edges of the diffusion evaporating panels 26, which is extremely limited. The water supply circuit 32 are put into operation and the ramps 40 deliver water to the upper part of the diffusion evaporating panels 26. This water flows by gravity into the panels, through the cellulose fibers in this case. The indoor air extractors 34 are activated and create a vacuum in the closed greenhouse. Outside air is therefore introduced into the closed greenhouse through the air intakes 28 and especially through the ducts 30. The air circulation leads this outside air through the evaporating diffusion panels 26 and because of the depression generated in the greenhouse by the interior air extractors 34, this air is extracted from the panels to diffuse itself into the general space of the closed greenhouse. As it passes through the panel, the air is infused with moisture and when it is extracted from the evaporating diffusion panel, evaporation occurs and therefore a decrease in the temperature of the air occurs by the adiabatic effect linked to this liquid/vapor phase change, a transformation which is endothermic. The air circulates in the greenhouse space giving it a given humidity level before being extracted from the interior space of the greenhouse by the extractors. The air circulates from the evaporating diffusion panels 26 at ground level to the interior air extractors 34 so that there is a relatively laminar flow of air from the bottom to the top on the one hand and from one side wall to the other on the other hand, which contributes very strongly to a homogenization of the temperature as well as of the hygrometric rate.

As shown in FIG. 4, the greenhouses may comprise several modules 10-1 to 10-n in a row. The roof 24 covers the entire production area and comprises as many vertical sections as there are modules. In the illustrated embodiment, the closed greenhouse 10 always comprises only one front wall, one rear wall and two side walls, one right and one left, the intermediate walls having been removed. Additions such as entrances with airlocks are arranged according to the needs on the front and rear walls, the side walls being provided with rows of evaporating diffusion panels 26. On the other hand, evaporating diffusion panels 26 are arranged between the modules, in lines, with interruptions to generate transverse circulation aisles, between the modules, without having to go to the ends. Thus, each module 10-1 to 10-n has two lines of diffusion evaporating panels and one line of indoor air extractors. This further homogenizes the diffusion in the space of the closed greenhouse with two circulations that are grouped near the extractors.

1. An arrangement of a dosed greenhouse (10) with optimised temperature control, including at least one module (10-1 to 10-n), comprising a framework and peripheral film so as to constitute an enclosed space, comprising a front wall (16), a rear wall (18) and two side walls, one left (20) and one right (22) as well as a roof (24) with a ridge, as well as at least one access opening with an airlock, at least one evaporating panel (26) for water diffusion, a water supply circuit (32) and at least one interior air extractor (34), characterized in that said at least one interior air extractor (34) is disposed in the immediate vicinity of the ridge of the roof (24).

2. The arrangement of a dosed greenhouse (10) with optimised temperature control, according to claim 1, characterised in that the at least one interior air extractor (34) is disposed vertically.

3. The arrangement of a dosed greenhouse (10) with optimised temperature control, according to claim 1, characterised in that the roof (24) comprises vertical, recessed roof panels (24-1) to which the interior air extractors (34) are mounted.

4. The arrangement of a closed greenhouse (10) with optimised temperature control, according to claim 1, characterized in that external air intakes (28) are provided, which penetrate the film in a sealed manner and open into the enclosed space.

5. The arrangement of a dosed greenhouse (10) with optimised temperature control, according to claim 4, characterised in that the external air intakes (28) are joined to the diffusion evaporating panels (26) by conduits (30).

6. The arrangement of a dosed greenhouse (10) with optimised temperature control, according to claim 1, characterized in that the at least one diffusion evaporating panel (26) is disposed in close proximity to a side wall (20, 22).

7. The arrangement of a dosed greenhouse (10) with optimised temperature control, according to claim 1, characterized in that the at least one diffusion evaporating panel (26) is disposed in close proximity to the ground.

8. The arrangement of a dosed greenhouse (10) with optimised temperature control, according to claim 1, characterized in that, the extractors (34) are motorized and the water supply circuit (32) includes pumps; an electrical supply is provided through photovoltaic panels.

9. The arrangement of a dosed greenhouse (10) with optimised temperature control, according to claim 1, characterised in that the external air intakes (28) and the interior air extractors (34) comprise anti-intrusion nets to control pests.

10. The arrangement of a dosed greenhouse (10) with optimised temperature control, according to claim 1, characterized in that programmable computer control means (46) manage the various water supply and extracted air flow rate parameters on the basis of the outside air parameters and the parameters sought in the said dosed greenhouse.

11. Multi-module greenhouse comprising at least two modules (10-1 to 10-n) arranged according to claim 3, the roof (24) spanning the entire production area and comprising as many vertical sides as there are modules as well as a front wall, a rear wall and two right and left side walls.

12. A multi-module greenhouse comprising at least two modules (10-1 to 10-n) arranged according to claim 1, characterized in that the diffusion evaporating panels (26) are shared and arranged between the paired modules.
